(19) United States
(12) Patent Application Publication
(10) Pub. No.: US 2014/0230298 A1
(43) Pub. Date: Aug. 21, 2014

(54) EXTRUDED FIREARM RECEIVER AND METHOD

(71) Applicant: MAG Tactical Systems, LLC, Bargersville, IN (US)

(72) Inventor: William Carr King, Jr., Newburgh, IN (US)

(21) Appl. No.: 14/056,890

(22) Filed: Oct. 17, 2013

Related U.S. Application Data
(60) Provisional application No. 61/846,674, filed on Jul. 16, 2013.

(51) Int. Cl. F41A 3/66; F41A 19/10; F41A 21/00; B21C 23/02; B23P 15/00

(52) U.S. Cl. CPC F41A 3/66; B21C 23/02; B23P 15/00; F41A 21/00; F41A 19/10
USPC 42/16; 72/254; 29/428

(57) ABSTRACT

A firearm receiver formed out of an extruded body. The receiver can be a lower receiver adapted for use in a modular rifle having both an upper receiver securable to a barrel and a lower receiver housing a trigger assembly. The receiver includes a bore extending completely through the receiver wherein the bore is formed during the extrusion process. Also disclosed is a method of manufacturing a firearm receiver that includes extruding the receiver with a bore extending through the extrusion. The process may be advantageously employed to form the lower receiver of a modular rifle wherein the bore formed during the extrusion process defines the magazine well of the rifle.

### CROSS REFERENCE TO RELATED APPLICATIONS

This application claims priority under 35 U.S.C. 119(e) of U.S. provisional patent application Ser. No. 61/846,674 filed on Jul. 16, 2013 entitled EXTRUDED ALUMINUM FIREARM RECEIVER AND METHOD the disclosure of which is hereby incorporated herein by reference.

### BACKGROUND OF THE INVENTION

1. Field of the Invention

The present invention relates to firearms and, more particularly, to firearm receivers and methods of manufacturing firearm receivers.

2. Description of the Related Art

Firearms generally include three main parts, the barrel through which a projectile, e.g., a bullet, is fired; the action which includes the moving parts that provide for the loading, firing, ejection of fired casing, and unloading; and either a stock (shotguns and rifles) or grip (handguns). The receiver houses most, if not all, of the operating parts that form the action of the firearm. The receiver is often made out of steel or aluminum. Under U.S. law, the receiver is generally the legally controlled part that is considered to constitute the firearm itself and which has a serial number fixed thereon.

While many firearms have a unitary receiver, some have multiple receivers. For example, one common form of firearm, often referred to as an AR-style rifle, has both an upper and lower receiver which are detachably secured together. This type of rifle gets its name from the AR-15 originally introduced by Armalite and which was adopted by the U.S. military as the M-16 rifle. The M-16 is a selective fire weapon capable of both semi-automatic and fully automatic operation. A civilian version of the M-16 capable only of semi-automatic fire was subsequently developed by Colt's Manufacturing Company and sold as the Colt AR-15. For AR-style rifles, the lower receiver generally constitutes the serialized component that is legally controlled as a firearm.

AR-style rifles are modular rifles which include an upper receiver assembly having an upper receiver, a bolt carrier, a barrel and a handguard. The lower receiver assembly includes a lower receiver which houses a trigger assembly and has a port for receiving a magazine. A pistol grip and stock can be attached to the lower receiver.

The modular nature of the rifle provides several benefits. For example, it allows the rifle to be easily customized for a particular application. The modular nature of the rifle also allows an individual component or one of the sub-assemblies to be easily replaced if the original is damaged or an alternative design is preferred. The many advantages provided by AR-style rifles have led such rifles to become one of the most popular styles of firearm produced today.

While conventional AR-style rifle designs and manufacturing techniques are capable of producing satisfactory rifles, improved cost-efficiency in the manufacture of such rifles and design modifications which improve the manufacturability remain desirable.

### SUMMARY OF THE INVENTION

The present invention provides an extruded receiver that allows for the cost-efficient and rapid manufacture of firearms using such a receiver. In one embodiment, the receiver is a lower receiver for an AR-style rifle.

The invention comprises, in one form thereof, a firearm that includes a receiver with an extruded body, a trigger assembly operably coupled with the receiver and a barrel operably coupled with the receiver and wherein the receiver has a through bore formed therein during the extrusion process.

The through bore may advantageously define an opening for receiving a magazine. In some embodiments, the firearm is a modular rifle having an upper receiver securable to a barrel and a lower receiver housing a trigger assembly and wherein the extruded body is the lower receiver. The extruded body may include aluminum material in some embodiments. In alternative embodiments, the receiver includes a magnesium material.

The invention comprises, in another form thereof, a method of manufacturing a firearm receiver that includes extruding a material to form an extruded body having a bore extending through the extruded body and machining the extruded body to form the firearm receiver.

In some embodiments, the bore formed in the extrusion defines an opening for receiving a magazine. The receiver may be machined to have a configuration which adapts the receiver for use as a lower receiver in a modular rifle having both a lower receiver housing a trigger assembly and an upper receiver securable to a barrel. The method may also include the step of assembling a modular rifle with the extruded body forming the lower receiver of the rifle.

In some embodiments, the extruded body formed by the step of extruding a material defines a first length and the method further comprises cutting the extruded body into a plurality of blanks and the step of machining the extruded body to form the firearm receiver comprises machining each of the plurality of blanks to form a corresponding plurality of firearm receivers.

In some embodiments, the step of extruding a material comprises extruding a billet of material. The billet of material may be at ambient temperature when extruded. Alternatively, the billet may be heated to a temperature above the recrystallization temperature of the material being extruded. In yet other embodiments, the billet is heated to a temperature between the ambient temperature and the recrystallization temperature of the material when extruded. The extruded material is, in some embodiments, an aluminum material. In other embodiments, the extruded material is a magnesium material.

Advantageously, the machining of the receiver is completed entirely by machining equipment that does not include a broaching machine. The formation of the through bore in the extruded body allows for the elimination of the need to use a broaching machine.

### BRIEF DESCRIPTION OF THE DRAWINGS

The above mentioned and other features of this invention, and the manner of attaining them, will become more apparent and the invention itself will be better understood by reference to the following description of an embodiment of the invention taken in conjunction with the accompanying drawings, wherein:

FIG. 1 is a side view of a firearm having an extruded lower receiver.

FIG. 2 is another side view of the firearm.

FIG. 3 is view of the firearm broken down into several major sub-assemblies.

FIG. 4 is an exploded view of the lower receiver and extension assembly, buttstock and grip.

FIG. 5 is a perspective view of a lower receiver.

FIG. 6 is an end view of the lower receiver.

FIG. 7 is a top view of the lower receiver.

FIG. 8 is a side view of the lower receiver.

FIG. 9 is a bottom view of the lower receiver.

FIG. 10 is another end view of the lower receiver.

FIG. 11 is another side view of the lower receiver.

FIG. 12 is a cross sectional view taken along line 12-12 of FIG. 9.

FIG. 13 is a perspective view of a magazine.

FIG. 14 is an exploded perspective view of a magazine.

FIG. 15 illustrates the insertion of a magazine into a firearm.

FIG. 16 illustrates the removal of a magazine from a firearm.

FIG. 17 is a perspective view of an extrusion that can be machined to form a lower receiver.

FIG. 18 is an end view of the extrusion of FIG. 17.

FIG. 19 is a side view of the extrusion of FIG. 17.

FIG. 20 is a schematic view of an extruder.

FIG. 21 is a side view of an extrusion.

FIG. 22 is a cross sectional view of the die of FIG. 20 taken along line A-A of FIG. 23.

FIG. 23 is an end view of the die of FIG. 20.

FIG. 24 is a schematic view of a CNC machining center.

Corresponding reference characters indicate corresponding parts throughout the several views. Although the exemplification set out herein illustrates an embodiment of the invention, in one form, the embodiment disclosed below is not intended to be exhaustive or to be construed as limiting the scope of the invention to the precise form disclosed.

### DETAILED DESCRIPTION OF THE INVENTION

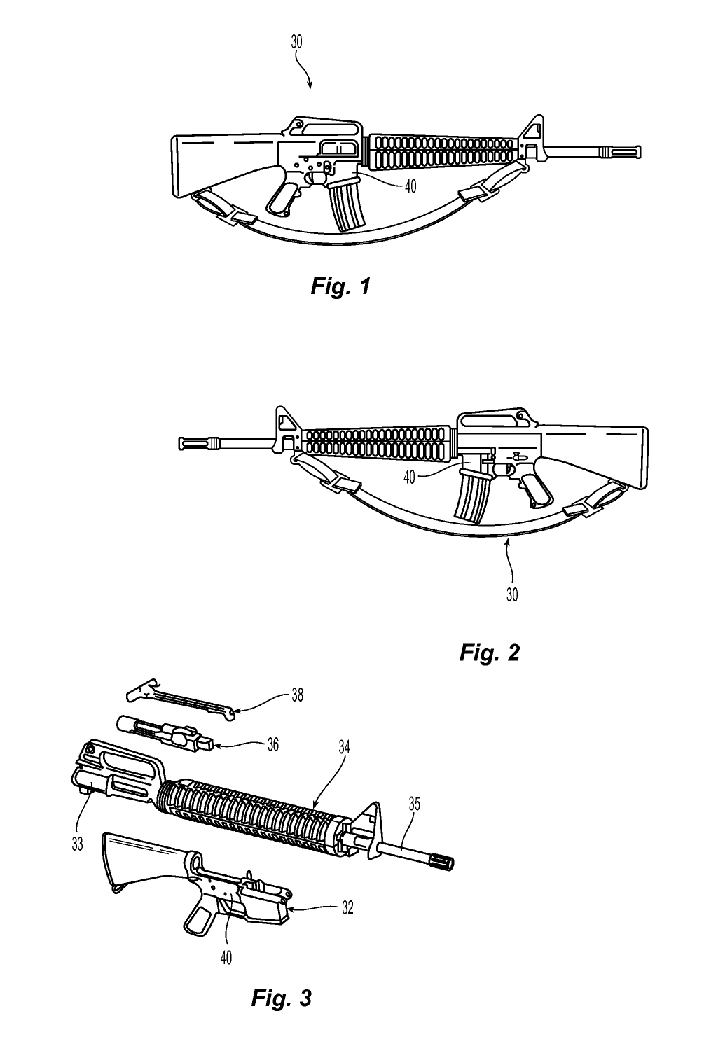

A firearm 30 having a lower receiver in accordance with the present invention is shown in FIGS. 1-3 with the major sub-assemblies of firearm 30 being labeled in FIGS. 1 and 2. Firearm 30 is an AR-style rifle and, except for lower receiver 40, has a conventional design and construction which is well-known to those having ordinary skill in the art.

FIG. 3 illustrates firearm 30 with several of the major sub-assemblies being disconnected. More specifically, firearm 30 has been broken down to separate the lower receiver and extension assembly 32, the upper receiver and barrel assembly 34, the bolt and carrier group 36, and the charging handle 38. These sub-assemblies, e.g., lower receiver and extension assembly 32 and upper receiver and barrel assembly 34, can be further broken down into still smaller modular assemblies.

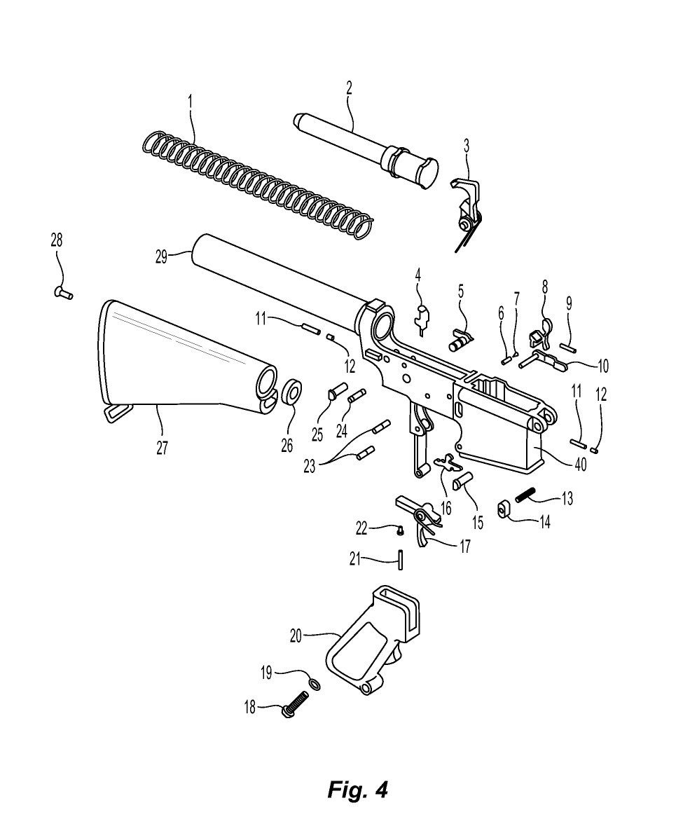

FIG. 4 provides an exploded view of the lower receiver and extension assembly 32. Illustrated in FIG. 4 are helical compression spring 1, buffer assembly 2, hammer assembly 3, sear 4, selector lever 5, helical compression spring 6, bolt catch plunger 7, bolt catch 8, spring steel pin 9, magazine catch 10, helical compression spring 11, pin 12, helical compression spring 13, magazine catch button 14, pivot pin 15, disconnector 16, trigger assembly 17, screw 18, lock washer 19, grip 20, helical compression spring 21, safety detent 22, grooved pin 23, grooved pin 24, takedown pin 25, stepped spacer 26, buttstock assembly 27, self-locking screw 28 and receiver extension tube 29. The assembly and operation of the parts shown in FIG. 4 will be understood by those having ordinary skill in the art.

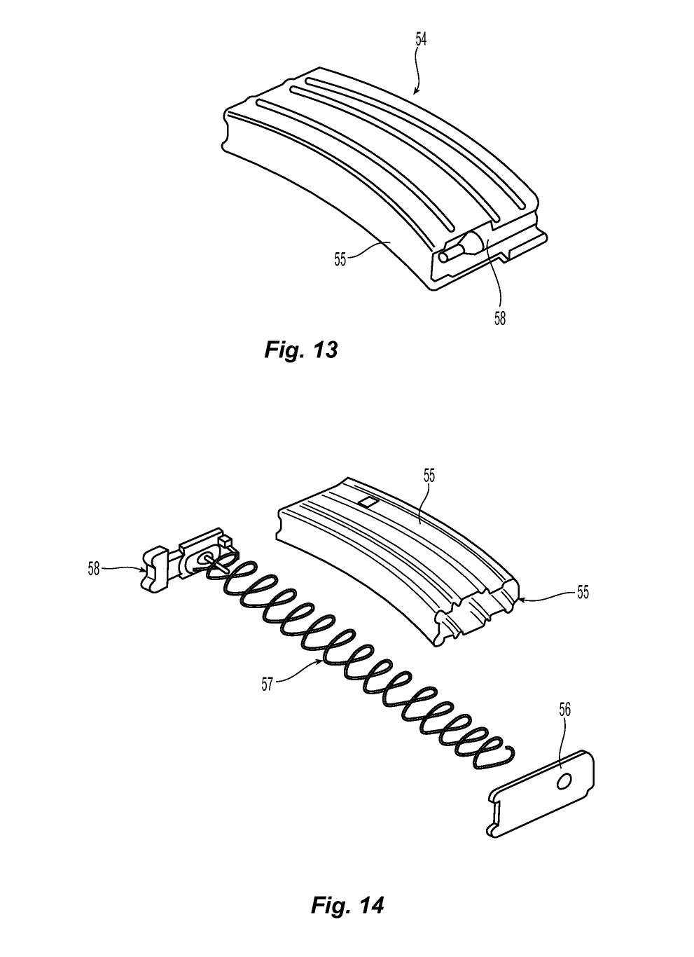

A detachable magazine 54 is used with firearm 30 and is shown in FIGS. 13-16. FIG. 13 illustrates an assembled magazine with can be used to feed ammunition in firearm 30. Magazine 54 is empty in FIG. 13. FIG. 14 is an exploded view of magazine 54. The main body of magazine 54 is formed by magazine tube 55. An end plate 56 is secured to one end of tube 55. Within tube 55, a spring 57 is positioned between end plate 56 and follower 58. Spring 57 biases follower 58 toward the magazine opening and thereby also biases ammunition within magazine 54 toward the dispensing end of magazine 54. The illustrated magazine 54 is a conventional AR style magazine well known to those having ordinary skill in the art.

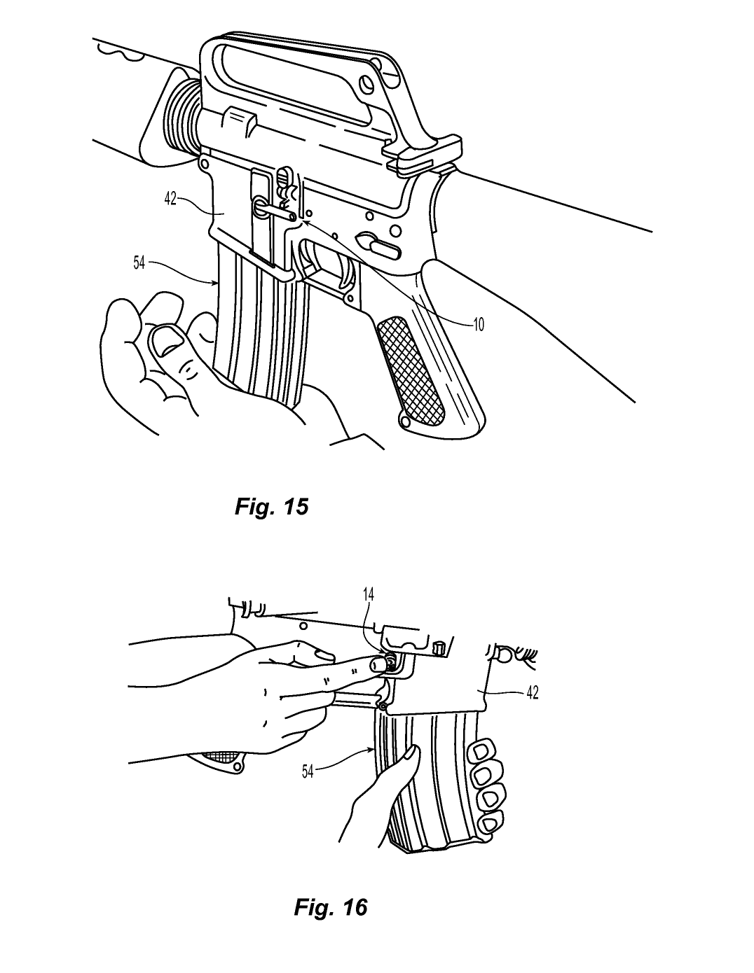

FIG. 15 illustrates the insertion of magazine 54 through opening 43 of magazine port 42 into magazine well 64. FIG. 16 illustrates how magazine 54 can be removed from magazine port 42 by depressing magazine catch button 14. It is further noted that the interior void defined by magazine port 42 which receives magazine 54 is referred to herein as magazine well 64. Magazine well 64 extends entirely through lower receiver 40 and is in communication with upper receiver and barrel assembly 34 whereby ammunition may be fed from magazine 54 to the upper receiver assembly and barrel assembly 34.

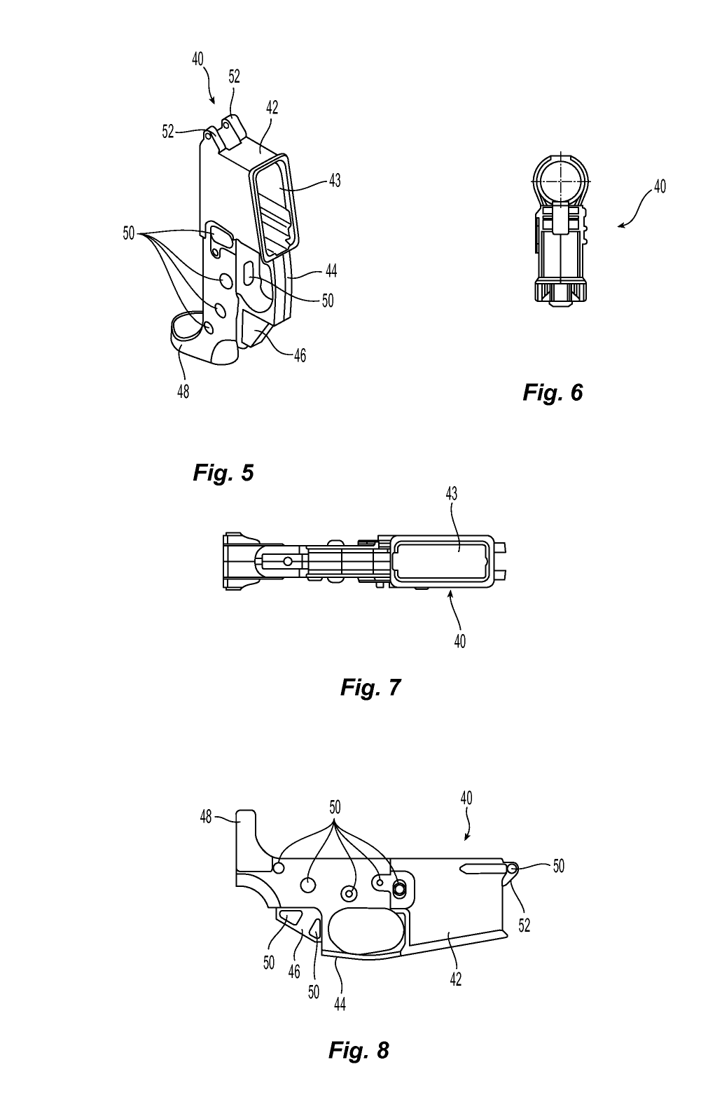

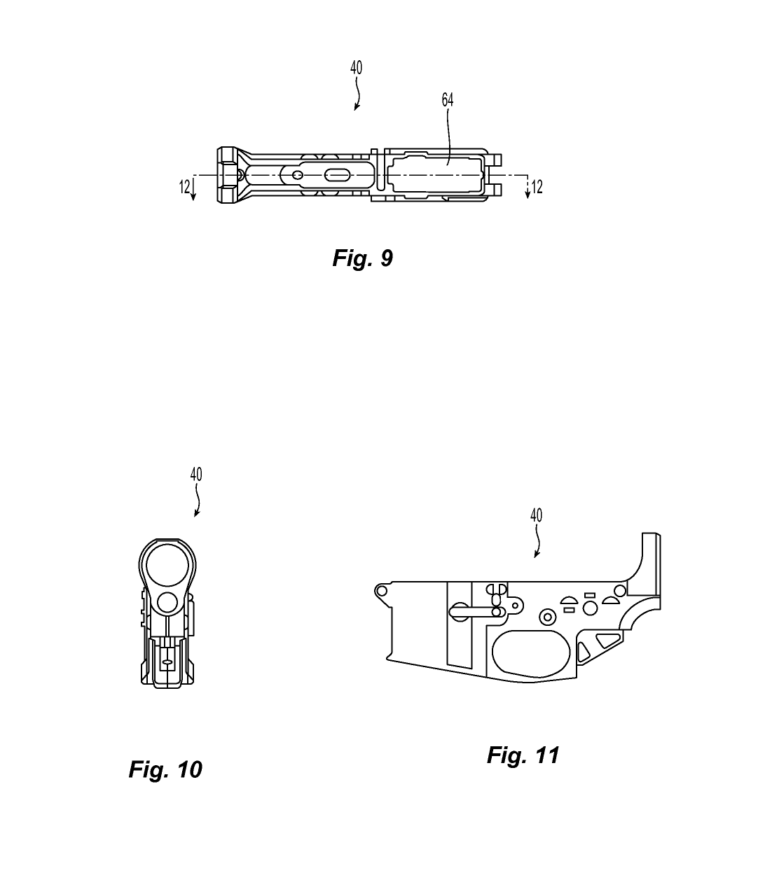

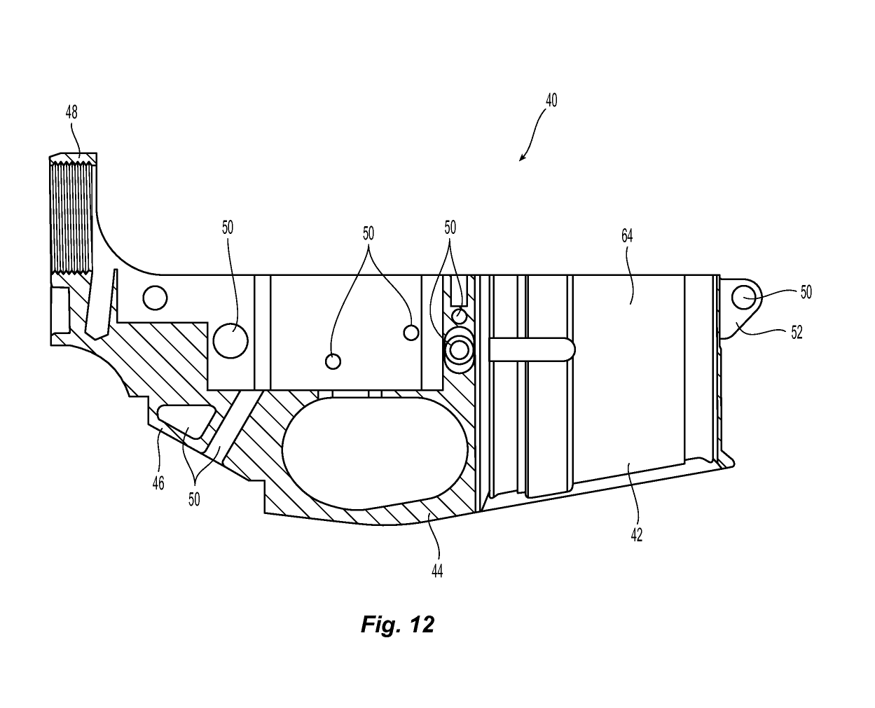

Lower receiver 40 is shown in greater detail in FIGS. 5-12. The illustrated receiver 40 is formed by extruding a material such as an aluminum or magnesium material. In this regard, it is noted that lower receivers for AR-style rifles are most commonly forged aluminum parts which requires working and extensive machining. As discussed in greater detail below, by extruding receiver 40 with a magazine well formed therein, the amount of machining required to form receiver 40 is reduced and the quantity of material which must be removed by the machining process is significantly reduced. The serial number must be unique for each receiver 40 and, thus, the text corresponding to the serial number of receiver 40 will typically need to be individually machined on each receiver.

As mentioned above, a lower receiver 40 which has been machined and is in its final form is illustrated in FIGS. 5-12. Receiver 40 includes a magazine port 42, a trigger guard 44, a mounting bracket 46 for attachment of a pistol grip, a threaded opening 48 for attachment of an extension tube, several small openings and slots 50 through the sidewalls of the receiver and pivot brackets 52 for pivotally and detachably mounting an upper receiver assembly to lower receiver 40. Openings 50 allow for installation of pins used in the securement of the trigger assembly. Openings 50 also allow for the projection of parts, e.g., one opening 50 facilitates the mounting of a selector that enables a user to engage and disengage the safety of the firearm.

It is noted that the trigger guard 44 of lower receiver 40 shown in FIGS. 5-12 differs slightly from that depicted in FIG. 4. In FIG. 4, the trigger guard includes a detachable member. In FIGS. 5-13, trigger guard 44 is unitary and fully encloses the trigger area. Both embodiments can be employed with the present invention.

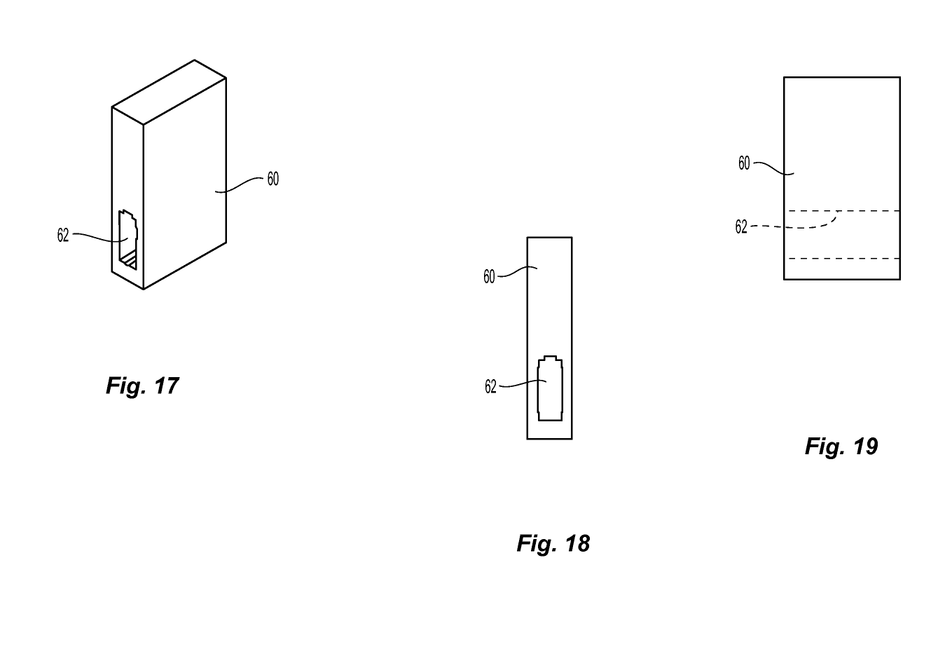

Turning now to FIGS. 17-24, the manufacture of lower receiver 40 will be discussed. FIGS. 17-19 illustrate an extruded body or extrusion 60 after it has been extruded and cut to length and without any further processing. A bore 62 extending entirely through extrusion 60 is formed in extrusion 60 during the extruding process. After forming extrusion 60 with bore 62 extending therethrough, extrusion 60 is machined to form lower receiver 40. In the finished receiver, bore 62 defines magazine well 64. Bore 62 is shaped so that only minimal machining of the inside surface of bore 62 is needed to form magazine well 64.

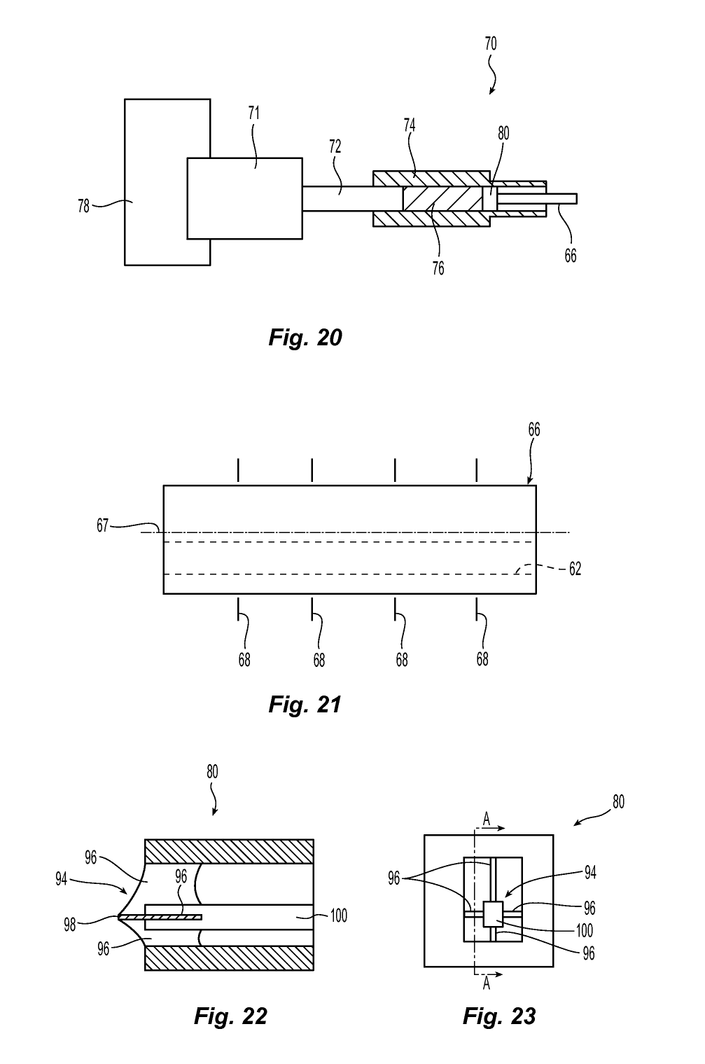

FIG. 20 schematically depicts an extruder 70 that can be used to form extrusion 60. Extruder 70 includes a hydraulic press 71 which powers a ram 72. Ram 72 extends into container 74 which holds a billet 76 of the material to be extruded. A dummy block, not shown, is placed between billet 76 and ram 72. A die 80 is installed at the end of container 74 opposite ram 72. Controls 78 govern the operation of extruder 70. As ram 72 is extended, billet 76 is forced through die 80 to form extrusion 66.

When using an extruder, the billet may either be cold or heated. In a cold extrusion process, the billet is placed in the container in a solid form at ambient temperature. Alternatively, the billet may be heated before it is placed in the container. In a hot extrusion process, the billet is heated to a temperature above the recrystallization temperature of the material. In a warm extrusion process, the billet is heated to a temperature above the ambient temperature but below the recrystallization temperature of the material. Although aluminum can be cold extruded, when forming extrusion 66, a warm or hot extrusion process is advantageously employed. For example, the billet may be a 7075 aluminum alloy, however, alternative materials may also be employed with the present invention such as 7 series and 6 series aluminum alloys.

Magnesium alloy billets may also be extruded to form an extrusion 60, 66 out of a magnesium material. For example, the billet may be an AZ91D magnesium alloy. The composition of AZ91D magnesium alloys is known in the art and typically includes about 8.5-9.5% Al, 0.45-0.90% Zn, 0.17-0.4% Mn, <0.05% Si, <0.025% Cu, <0.001% Ni, and <0.004% Fe with Mg forming the balance of the alloy. This alloy has high strength and good corrosion resistance and is often used for the housings of electric appliances.

FIG. 21 illustrates the extrusion 66 that is produced by extruder 70. As can be seen in this figure, an elongate extruded body or extrusion 66 includes a bore 62 that extends parallel to longitudinal axis 67 for the full axial length of extrusion 66. Extended length extrusion 66 is subsequently cut transverse to axis 67 at a plurality of locations indicated by lines 68 to thereby form a plurality of extrusions 60, which are also referred to herein as extruded bodies and blanks, with each of the extrusions/extruded bodies/blanks 60 having a size suitable for machining into a receiver.

Although it is possible to use billets having a size that generates an extrusion having the axial length of extrusion 60 without any cutting transverse to axis 67. The use of a billet having a larger size to form an extended length extrusion 66 has several advantages. First, it is more efficient to form an extended length extrusion 66 and cut it into a plurality of smaller extrusions than to perform a larger number of extrusions of shorter lengths. Furthermore, the distance between cut lines 68 can be adjusted to easily form different receivers. For example, AR style rifles can be used with many different calibers of ammunition and the axial distance between cut lines 68 can be adjusted to allow a single die 80 to be used to form different axial length receiver blanks suitable for different caliber ammunition. For example, two of the most common calibers used with AR style rifles are the 5.56×45 mm NATO (and its civilian counterpart the .223 Remington) and the larger 7.62×51 mm NATO (and its civilian counterpart the .308 Winchester). It is noted that rifles adapted for use with the 5.56 NATO round are often designated AR-15 while those adapted for use with the 7.62 NATO round are typically designated AR-10. While the lower receivers of AR-15's and AR-10's are very similar, AR-10's typically have a longer magazine well, i.e., the receiver blank for an AR-10 will have a longer dimension along axial line 67. Thus, by forming an extended length extrusion 66 and adjusting the distance between cut lines 68, extrusion 66 can be used to form a plurality of lower receivers for either an AR-15 or an AR-10. For purposes of manufacturing efficiency it will generally be desirable to cut an extended length extrusion 66 into a plurality of smaller extrusions having the same axial length, however, it may be desirable when manufacturing small batches to cut a single extended extrusion 66 into a plurality of extrusions having different axial lengths.

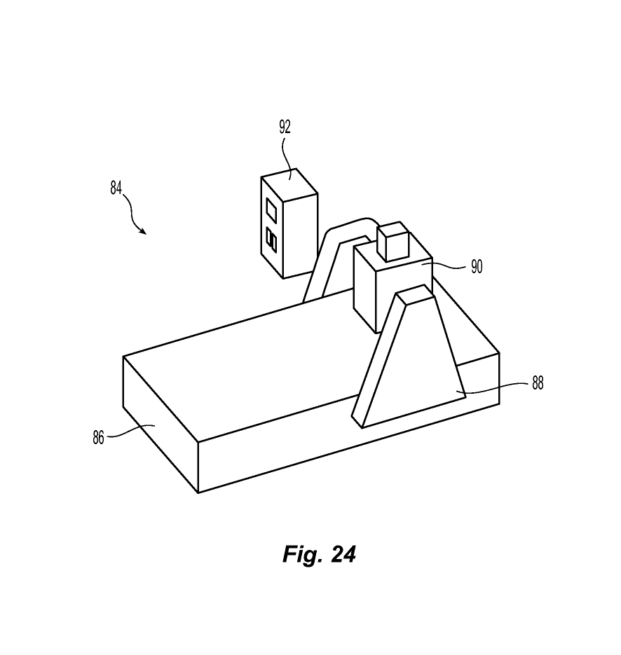

As depicted in FIG. 21, extrusion 66 has a bore 62 formed therein during the extrusion process. FIGS. 22 and 23 schematically depict a die 80 which can be used to form extrusion 66 having a bore 62 extending therethrough. As is known in the art, a mandrel can be used to form a centrally located opening in an extrusion. The illustrated die 80, includes a mandrel 94 having support legs 96 and a leading edge 98. The billet first contacts leading edge 98 and is pierced thereby. The support legs 96 support center die 100 which forms bore 62. The shape of center die 100 has been simplified in FIGS. 22 and 23. Support legs 96 are located only proximate the leading edge of die 80 and allow the material to reform within die 80 after passing by legs 96. Depending upon the precise parameters of the extrusion process, the finished extrusion 66 may include weld lines at the location of legs 96 as a result of the extrusion process. Once extrusion 66 is formed and has cooled, it is cut to length to form a plurality of extrusions 60 as discussed above.

After forming extrusion 60 having a bore 62 therein, extrusion 60 is machined to form lower receiver 40. FIG. 24 schematically depicts a CNC machining center 84 that can be used to machine extrusion 60 to form lower receiver 40. The illustrated CNC machining center 84 includes a workbed 86. A carriage 88 allows tooling 90 to be repositioned relative to workbed 86. A controller 92 controls the operation of the tooling 90. Various other machining equipment can also be used to machine extrusion 60.

A significant advantage of extrusion 60 having bore 62 formed therein is that no broaching equipment is necessary to form bore 62. If extrusion 60 were a solid rectilinear piece of metal, a broaching machine would typically be required to form a bore comparable to the depicted bore 62 in the material. Most CNC machining centers and comparable machining equipment are not capable of forming such a large bore thereby resulting in the need to use a separate, and relatively expensive, broaching machine. Many companies which currently machine lower receivers for use in AR style modular rifles do not own a broaching machine and must pay a subcontractor having such a broaching machine to form a bore having a shape similar to bore 62 in the block of material that they machine to form the lower receiver. By forming bore 62 in extrusion 60 during the extruding process, there is no longer a need to use a broaching machine in the manufacture of a lower receiver for a AR style modular rifle.

The forming of bore 62 in extrusion 60 during the extruding process also reduces the machining time, by eliminating the need to machine a bore through the material with a broaching machine, and reduces the quantity of scrap material that is generated during the machining process and which must either be recycled or discarded.

After machining receiver 40, it is tumbled in a ceramic media for deburring, then cleaned and provided with a surface finish. Once the surface of receiver 40 has been given the desired finish, receiver 40 is completed can be assembled in a firearm 30.

Receiver 40 can be provided with various known surface finishes. For example, when lower receiver 40 is formed out of an aluminum material it can be anodized in a conventional manner to provide it with an anodized finish. Alternatively, an aluminum lower receiver 40 can be plated. For example, a conventional electroplating process can be used with receiver 40, or, an electroless nickel plating process could be used to plate receiver 40. The electroplating of aluminum receivers formed by a forging process is well-known in the art and such a plating process can also be used with the extruded aluminum lower receiver 40 of the present application.

The electroless nickel plating process is an auto-catalytic chemical process that deposits a nickel-phosphorus layer on receiver 40. In an electroless nickel plating process, a reducing agent is used to react with metal ions to deposit metal on the object being plated. In the illustrated example, a layer of nickel is deposited on receiver 40. Unlike electroplating, electroless nickel plating does not require the use of an electrical current to form a deposit on the work piece. The absence of flux-density and power supply variations allows the electroless nickel plating process to provide a more even deposit on the complex geometry of receiver 40 than would an electroplating process. The use of an electroless nickel plating process also provides receiver 40 with a more durable coating than would a conventional ion-exchange chromating process.

When lower receiver 40 is formed out of a magnesium alloy, it will generally be desirable to plate the receiver. Advantageously, an electroless nickel plating process is used with the receivers that are formed out of a magnesium material.

While the present invention has been illustrated and described in the context of a lower receiver for an AR-style rifle, the present invention may be utilized with other firearm components and with receivers and other firearm components for other styles of firearms.

For example, firearms such as bolt-action rifles and handguns which have a receiver or frame defining a magazine well could be manufactured in the same manner described above for lower receiver 40. With regard to handguns, it is noted that the “receiver” of a handgun is often referred to as the frame.

Although many firearms with receivers/frames that define a magazine well will have a detachable magazine some will have alternative configurations, e.g., an internal magazine with a hinged floor plate. Similarly, other firearm receivers may have a large opening similar to a magazine well but having a different purpose. For example, a firearm may have a relatively large opening that functions as an ejection port. Still other firearms may have secondary openings with other purposes. Depending on the configuration of the firearm, many firearms having such openings will be capable of being manufactured according to the present invention.

The use of an extrusion process as described herein will provide the greatest advantages wherein the finished receiver/frame has a bore that extends entirely through the extruded part as exemplified by lower receiver 40. For some firearms, however, the magazine well or other large bore feature will define a blind bore instead of a through bore. Depending on the firearm design and strength requirements, many of these firearms can be manufacture using an extrusion having a through bore with a separate end plate attached to the receiver/frame to close off one end of the bore thereby allowing it to be manufactured in accordance with the present application.

While this invention has been described as having an exemplary design, the present invention may be further modified within the spirit and scope of this disclosure. This application is therefore intended to cover any variations, uses, or adaptations of the invention using its general principles.

What is claimed is:

1. A firearm comprising:
a receiver with an extruded body;
a trigger assembly operably coupled with the receiver;
a barrel operably coupled with the receiver; and
wherein the receiver has a through bore formed therein during the extrusion process.

2. The firearm of claim 1 wherein the through bore defines an opening for receiving a magazine.

3. The firearm of claim 2 wherein the firearm is a modular rifle having an upper receiver securable to a barrel and a lower receiver housing a trigger assembly and wherein the extruded body is the lower receiver.

4. The firearm of claim 1 wherein the extruded body comprises aluminum.

5. The firearm of claim 1 wherein the extruded body comprises magnesium.

6. A method of manufacturing a firearm receiver comprising:
extruding a material to form an extruded body having a bore extending through the extruded body;
machining the extruded body to form the firearm receiver.

7. The method of claim 6 wherein the bore defines an opening for receiving a magazine.

8. The method of claim 7 wherein the receiver is machined to have a configuration which adapts the receiver for use as a lower receiver in a modular rifle having both a lower receiver housing a trigger assembly and an upper receiver securable to a barrel.

9. The method of claim 8 further comprising the step of assembling a modular rifle with the receiver forming the lower receiver of the rifle.

10. The method of claim 6 wherein the extruded body formed by the step of extruding a material defines a first length and the method further comprises cutting the extruded body into a plurality of blanks and the step of machining the extruded body to form the firearm receiver comprises machining each of the plurality of blanks to form a corresponding plurality of firearm receivers.

11. The method of claim 6 wherein the step of extruding a material comprises extruding a billet of material.

12. The method of claim 11 wherein the billet is at approximately ambient temperature when extruded.

13. The method of claim 11 wherein the billet is heated to a temperature above the recrystallization temperature of the material when extruded.

14. The method of claim 11 wherein the billet is heated to a temperature between the ambient temperature and the recrystallization temperature of the material when extruded.

15. The method of claim 11 wherein the material comprises aluminum.

16. The method of claim 11 wherein the material comprises magnesium.

17. The method of claim 6 wherein the material comprises aluminum.

18. The method of claim 6 wherein the material comprises magnesium.

19. The method of claim 6 wherein the machining of the receiver is completed entirely by machining equipment that does not include a broaching machine.

20. The method of claim 19 wherein the step of extruding a material comprises extruding a billet of a material that comprises aluminum.
